(19) United States
(12) Patent Application Publication
(10) Pub. No.: US 2025/0333581 A1
(43) Pub. Date: Oct. 30, 2025

(54) Method of Cellulose Particles and Fibrils Compatibilization and Use Thereof as Reinforcements for Plastic Composites

(71) Applicant: TDA Research, Inc., Wheat Ridge, CO (US)

(72) Inventors: Brady Clapsaddle, Littleton, CO (US); Denis Kissuonko, Broomfield, CO (US); Frank McCoy, Longmont, CO (US); Darrin Miller, Littleton, CO (US); Girish Srinivas, Broomfield, CO (US)

(21) Appl. No.: 18/650,438

(22) Filed: Apr. 30, 2024

(51) Int. Cl. C08K 7/02

(52) U.S. Cl. CPC C08K 7/02; C08K 2201/005; C08K 2201/011

(57) ABSTRACT

A wet method for forming a nanocellulose or microcellulose reinforced polymer composite, comprising: providing an aqueous nanocellulose or microcellulose comprising a water content from 70 to 99.5 weight % water; adding 2-ethyl-1,3-hexanediol to the aqueous nanocellulose or microcellulose, forming a first combination; removing at least some water from the first combination, forming a second combination comprising 5-20 weight % water or 8-12 weight % water; adding the second combination to a nylon, wherein the nylon has a melting point above 200° C.; mixing the second combination and the thermoplastic resin while evaporating water from the second combination; and forming a nanocellulose or microcellulose-reinforced polymer composite. The produced composite has improved mechanical and environmental properties such as modulus, yield strength, and elongation at break. The method does not comprise any milling or pulverizing of the nanocellulose or microcellulose.

### STATEMENT OF GOVERNMENT INTEREST

This invention was made with United States government support under contract DE-SC0017849 awarded by the Department of Energy. The government has certain rights in this invention.

### BACKGROUND

The development of sustainable materials, including the development of novel plastic-based materials, is a growing priority in industrial manufacturing. Moving towards renewable raw materials, as well as environmentally friendly, sustainable resources and manufacturing processes is part of this process (Abdul Khalil, 2012). The addition of natural fibers to bio-polymers or recyclable thermoplastics has greatly contributed to the growing use of sustainable materials in manufacturing over the last couple of decades, especially in industries that use significant amounts of plastics, such as the automotive industry.

The automotive industry is faced with pressures to produce lighter weight, fuel efficient, low-polluting vehicles (Marsh, 2003). The use of high-strength fiber reinforced composite materials in cars has helped the industry achieve many of these goals, though the structural components used in cars still use synthetic, petro-based composites that are energy intensive to manufacture. The use of recyclable thermoplastics in the manufacture of these parts has helped decrease the carbon footprint, but improvements can still be made. One potential area of improvement is the replacement of synthetic glass, carbon, and aramid fibers in fiber reinforced thermoplastic composites (TPCs) with natural fibers.

Cellulose [(C6H10O5)ₙ] is the most abundant bio-polymer. While its main use is for paper production, in the last 5 years there has been a large surge in the production of cellulose nanomaterials for use in composite materials as replacements for synthetic fibers (e.g., glass, carbon). Cellulose nanofibrils (CNFs) have received growing attention over the last decade as an almost inexhaustible source of fiber additives to strengthen composite materials. CNFs have the potential to replace synthetic fibers with renewable, environmentally friendly additives. There are two major drawbacks, however, to their use in high-volume polymer composite materials: 1) strong hydrogen bonding interactions of the surface hydroxyl (OH) groups result in gelation of the materials; and 2) hydrophilic surface properties make it difficult to disperse CNFs in commonly used hydrophobic polymer resins. For CNFs to be widely used in applications that employ high-throughput fabrication techniques such as injection molding and compression molding (the automotive industry, clean energy components, etc.), these challenges must be overcome.

The popularity of crystalline cellulosic nanomaterials is due to their unique properties and sizes as compared to other natural fibers for these applications (e.g., flax, hemp, sisal). In addition, cellulose nanomaterials are environmentally friendly and renewable.

CNFs are cellulose nanofibers containing both crystalline and amorphous regions and widths of 5-30 nm with aspect ratios >50. CNF materials have received recent attention due to crystalline cellulose's high stiffness (140-220 GPa). For use as reinforcing fibers, it is desirable to have materials with a high aspect ratio, as this enables a critical length for stress transfer from the matrix material to the reinforcing fiber phase (Abdul Khalil, 2012). Due to their greater length, CNFs can become intertwined and interact with the polymer matrix (Miller, 2015).

Fiber reinforced polypropylene (PP) has received considerable interest due to its very widespread use, low price, light weight, and good durability. Compared to pure PP, CNF-reinforced PP has been shown to have a 36% increased tensile modulus, 11% increased tensile strength, 21% increased flexural modulus, 7% increased flexural strength, and 23% increased impact strength (Peng, 2014). Currently, GreenCore Composites, Inc. makes NCELL™ natural fiber reinforced thermoplastics consisting of polypropylene (PP) and polyethylene (PE) reinforced with up to 40% cellulose microfibers. These materials have mechanical properties equal to those of glass fiber reinforced thermoplastics and are available commercially.

While improved mechanical properties in plastics using CNF fillers has been demonstrated, there remain significant barriers to their adoption. The main barrier is the difficulty of dispersing the hydrophilic CNFs in the hydrophobic matrix of common commodity plastics. Current methods for dispersing CNFs in a plastic matrix rely on covalent modification of the CNFs and complete removal of moisture prior to mixing. An alternate method allowing for liquid dispersion is shown in xxx, but complete removal of the acetone is still required and there are no structural benefits in the produced polymers from this method.

The prior art still is deficient in providing a low-cost, simplified method of making reinforced polymers starting with the aqueous dispersions of the nanocellose and microcellulose. The prior art does not teach or suggest that weakly associated organic compounds are suitable for blending the hydrophilic cellulose with hydrophobic thermosetting polymers, nor does it anticipate or provide an enabling description of a combination of such a process. The prior art relies on expensive and complicated chemical synthesis steps to first form these covalently bonded surface groups on the cellulose (i.e. strongly bonded). Most importantly, the prior art teaches blending of CNF into a plastic media require the cellulose material when it is completely dry (JP2010143992; US20200102425A1). Drying of a cellulose material is an expensive and energy consuming process

### SUMMARY OF THE INVENTION

The present disclosure solves the limitations of the prior art by providing a method of making cellulose-reinforced polymer composites by using “wet” compounding method which avoids an expensive and energy consuming step of drying the cellulose product before blending with a plastic compound. The present invention describes the use of an organic compound such 2-ethyl-1,3-hexanediol as a water replacement agent and beneficial additive to compounded plastics that can act as both a compatibilizer for the cellulose and a plasticizer to improve properties such as flexible strength, thermal aging, and solvent resistance. The 2-ethyl-1,3-hexanediol not only facilitates the non-dry blending of cellulose and plastic materials, but also remains in the final reinforced polymer product (thereby avoiding any solution removal steps) and provides structural benefits. The disclosed method allows for reclamation of the compatibilizer/organic agent (such as EHD), thereby decreasing the environmental impact and waste of the overall production.

Therefore, the present method allows for blending the wet cellulose particles or fibrils directly into nylons, which require elevated processing temperatures, without drying and using the dispersion media as a beneficial plastic additive that improves a range of mechanical and environmental properties compared to unmodified plastic. The methods of the present disclosure provide thermoplastic and thermoset polymer composites with improved mechanical properties, including but not limited to storage modulus, elongation at break, toughness, as well as better retention of the abovementioned properties after environmental aging conditions and exposure to a variety of fluids. The improved properties are at least 10% better than the thermoset polymers without the cellulose. The blended “wet” slurry CNF slurry contains between 10-20% of the CNF fibrils, 10-20% of the residual water, and the balance is the organic media (EHD) which also act as a beneficial additive in a compounded plastic. The residual moisture evaporates during the compounding process; thus, is not a part of the final formulation.

The disclosure provides a method of modification of cellulosic particles of nanosize or microsize to remove the moisture incompatible with thermoset and thermoplastic resins, specifically nylons; compatibilize the surface of the particles to become dispersible in the plastic matrix, compounding modified cellulosic particles with thermoset and thermoplastic resins; and exhibit mechanical and environmental improvements of the plastics.

The disclosure provides a method for forming a nanocellulose or microcellulose-reinforced polymer composite, comprising: providing an aqueous nanocellulose or microcellulose comprising a water content from 70 to 99.5 weight % water; adding a 2-ethyl-1,3-hexanediol to the aqueous nanocellulose or microcellulose, forming a first combination wherein the 2-ethyl-1,3-hexanediol is not covalently bonded to the aqueous nanocellulose or microcellulose; removing at least some water from the first combination, forming a second combination comprising 5-20 weight % water; adding the second combination to a nylon, wherein the nylon has a melting point above 200° C.; mixing the second combination and the nylon while evaporating water from the second combination; forming a nanocellulose or microcellulose-reinforced polymer composite; and, wherein the method does not comprise a step of pulverizing or milling the nanocellulose or microcellulose. Alternatively, removing at least some water from the first combination forms a second combination comprising 8-12 weight % water.

In an optional embodiment, the method further comprises adding an antioxidant in addition to the 2-ethyl-1,3-hexanediol to the aqueous nanocellulose or microcellulose, forming the first combination. Preferably, the first combination comprises 0.5 to 1 weight % antioxidant.

Preferably, the nanocellulose or microcellulose-reinforced polymer composite has improved mechanical and environmental properties, comprising improved tensile strength and modulus, flexural strength and modulus, short beam shear strength and modulus, flexural fatigue, compression strength and modulus, and abrasion before and after environmental exposure compared to a polymer composite without a nanocellulose or microcellulose additive.

In another embodiment, the aqueous nanocellulose or microcellulose comprises CNF, CNC, or CMP. Preferably, it comprises CNF. In an embodiment, the nylon is Nylon 6.

In an embodiment, the first combination comprises 5 to 15 weight % 2-ethyl-1,3-hexanediol. The nanocellulose or microcellulose-reinforced polymer composite may comprise a ratio of the nanocellulose or micro-cellulose to the 2-ethyl-1,3-hexanediol of 1±0.1 to 8±0.8. The nanocellulose or microcellulose-reinforced polymer composite may comprise 1-20 weight % of the nanocellulose or microcellulose and 99-80 weight % of the nylon and other additives.

### BRIEF DESCRIPTION OF FIGURES

FIG. 1: Interaction between a cellulose molecule and an EHD diol molecule.

FIG. 2: Comparison of modulus, yield stress, elongation at break for Nylon 6 baseline plastic and its composites with CNF and EHD

FIG. 3: Results from humidity exposure study (modulus, yield stress, elongation at break).

FIG. 4: Results from oil aging study (modulus, yield stress, elongation at break).

FIG. 5: Results from thermal aging study (modulus, yield stress, elongation at break).

FIG. 6: Comparative tensile results for CNF/EHD/Zytel® 158 resin blends with variable EHD load.

FIG. 7: Comparative tensile results for CNF/EDH/Zytel® 158 resin blends with variable CNF load.

FIG. 8: TGA traces of CNF/EHD slurry after the second and the third dispersion/filtration steps.

### DETAILED DESCRIPTION OF THE INVENTION

The present disclosure provides a method for making a nanocellulose-reinforced polymer composites, comprising of aqueous nanocellulose, wherein the aqueous cellulose is either a plurality of cellulose microparticles, a plurality of cellulose nanocrystals, or a plurality of cellulose nanofibrils dispersed in water; whereupon the water is first being partially replaced by 2-ethyl-1,3-hexanediol, followed by blending of the wet cellulose filler into a nylon. The present disclosure provides a “wet” method for compatibilizing the nanocellulose, which avoids the expensive, time-consuming, and energy-consuming step of drying the modified nanocellulose prior to compounding with the thermoplastic and provides easy dispersion of the material. The method described herein produces a homogenous, strengthened polymer composite product comparable or superior to those made by “dry” methods (including steps of fully drying CNF or modified CNF material).

The combination of a nylon with a cellulose filler may contain 1% to 20% wt. of the cellulose, and 99% to 80% of a nylon or other additives. The loadings in excess of 20% wt. of cellulose were proven to be less efficient both in terms of the cost of the product and mechanical properties of the cellulose/plastic blend. The cellulose particles in the preferred embodiment were nanosized CNF or CNC materials. In another example the invention shows that both CNC and CNF yield approximately the same improvements of yield stress at approximately 30%. The modulus improvement was considerably higher for CNC additive with 20% increase, whereas CNF remained at the baseline level. However, the elongation at break was higher by 37% for CNF compared to CNC.

Unless defined otherwise, all technical and scientific terms used herein have the same meaning as commonly understood by one of ordinary skill in the art to which the invention belongs. All abbreviations used in the description of the invention are described in the embodiments.

The term “CMP” means cellulose microparticle and is defined as either a spherical or an elongated cellulose plurality of particles with diameter from 20 to 400 microns.

The term “CNF” means cellulose nanofibrils and is cellulose particles with diameter range between 5-20 nm and the length between 500-2,000 nm. The aspect ratio is at least 10.

The term “CNC” means cellulose nanocrystals with either spherical or elongated geometry and with a diameter from 100 to 1,000 nm.

The term “organic compatibilizer” means an organic compound that can interact (non-covalently) with both the hydroxyl surface groups of a surface polymer and thermoplastic or thermoset resin media. Organic compatibilizers include, but are not limited to, alcohols, diols, polyols, ketones, and amines.

The term “nylon” means a polyamide polymer characterized by the presence of amide group(s) (CO—NH) in the main polymer chain. The term points to a family of synthetic polymers composed of polyamides linked by amide links. Examples of nylons include but are not limited to Nylon 6, Nylon 66, Nylon 11, Nylon 12, Nylon 6/12, Nylon 6/9, Nylon 6/10.

The term “Elvamide®” means a thermoplastic polyamide resin that combines the inherent toughness of nylon with ease of processing in solvent as well as melt systems. Elvamide® resins differ from conventional nylons in that they offer: alcohol solubility, lower melt-processing temperatures, high elongation, ability to cross-link with thermosetting resins.

The term “Zytel®” means a family of high-strength, abrasion and impact-resistant thermoplastic polyamide formulations, characterized by its hardness and resistance against external influences. They are nylon-like plastics that can be shaped at high temperatures. Zytel® is a modern composite material distinguished by its high hardness and excellent resistance to abrasion, heat, cold, moisture, and chemicals.

The present method relies of providing a wet nanocellulose or microcellulose, which may have a water content from 70 to 99.5 weight % water, or 80 to 99.5 weight % water, or 85 to 99.5 weight % water, or 90 to 99.5 weight % water.

Once the nanocellulose or microcellulose is added to an organic compatibilizer, preferably 2-ethyl-1,3-hexanediol (EHD), the water content must be reduced to more than 0 and up to 20 weight % water, or 1-20 weight % water, 3-20 weight % water, 5-20 weight % water, 6-20 weight % water, 7-20 weight % water, 10-20 weight % water, 12-20 weight % water, or 15-20 weight % water.

The present method blends an aqueous nanocellulose or microcellulose with an organic compatibilizing agent, forming a first combination that is then blended with a high-melting plastic polymer. The high-melting plastic polymer may have a melting point of over 180° C., over 190° C., over 200° C., over 205° C., over 210° C., over 215° C., over 220° C., over 225° C.

A key aspect of the invention is that the hydroxyl (—OH) surface groups of a cellulose polymer can be compatibilized with 2-ethyl-1,3-hexanediol, which can form a hydrogen bond with a hydroxyl group through a non-covalent interaction. Such surface modification allows for a better dispersion of the cellulosic products in a nylon plastic matrix, removal of water from the cellulose product, and plastification of the final plastic composite without a need of drying the cellulose reinforcement. The slurry of cellulose nanoparticles in a liquid compatibilizer can be blended directly with a nylon through a solution-based method. This avoids high energy and time-consuming process of dying and milling cellulose fibrils, while still producing a highly homogenous polymer product with improved properties.

The method of the present disclosure begins with providing a wet nanocellulose with a water content from 70 to 99.5 weight %, or 80 to 99.5% or 90 to 99.5%. The types of cellulosic products used may include, but are not limited to, Cellulose Nanofibers (CNF), Cellulose Nanocrystals (CNC), and Cellulose Microparticles (CMP). The cellulose products are used in an aqueous suspension form.

An organic compatibilizer, preferably 2-ethyl-1,3-hexanediol, is added to the aqueous nanocellulose or microcellulose, forming a first combination slurry. It is a teaching of this disclosure that 2-ethyl-1,3-hexanediol both interacts with the surface of the cellulose, making the cellulose more compatible and dispersible in the plastic matrix, and supports a formation of a slurry that is compatible with the plastics. Additional possible organic compatibilizers include, but are not limited to, alcohols, diols, polyols, ketones, and amines. Preferably, the organic compatibilizer is a diol or polyol, such as 2-ethyl-1,3-hexanediol. The compatibilizer does not covalently bond to the nanocellulose or microcellulose. The slurry of cellulose nanoparticles in a liquid compatibilizer can be blended directly with a plastic through the solution-based method described herein. Otherwise, water content is not compatible and cannot be blended into the plastics, and it needs to be removed or mostly removed prior to blending, which requires high energy, time, and/or expensive equipment. By blending a compatibilized slurry, the present method allows up to 20 weight % water content remaining in the cellulose and compatibilizer combination prior to mixing with the thermoplastic or thermoset resin.

The examples herein demonstrate that unmodified cellulose micro-and nanocellulose sized particles suspended in a compatible liquid organic medium when blended with the common plastics considerably improve such properties as tensile strength and modulus, abrasion, and thermal aging. The organic compatibilizer allows up to 20% water content to remain in the slurry for blending with high-melting-point plastics, for example thermoplastic resins with a melting point above 200° C. Excess water is evaporated during the blending step, so no additional drying, pulverizing, or heating is required to obtain the final reinforced polymer product. The present “wet” method provides a more efficient process for forming nanocellulose-reinforced or microcellulose-reinforced polymer composites in terms of time, energy, complexity, and expense. No separate pulverizing or water removal is necessary, as is required in current methods for forming reinforced polymers from “dry” modified or unmodified cellulose materials.

In preliminary use of the wet cellulose particles suspended in a compatibilizing organic compound, the mixture was first analyzed by the Thermogravimetric Analysis (TGA) or other techniques to obtain the amounts of cellulose solid content, organic compatibilizer, and light residual volatiles (e.g., residual moisture content). The plastic blend composition can be calculated based on the weight percent composition obtained by analysis. The composition of a wet mixture can be tailored by optional additional filtration or pressing step, whereupon the additional amounts of liquids can be removed from the blend. There is no need for milling, pulverizing, or complete drying; instead, the wet slurry can be blended directly with plastic pellets in a pre-extrusion step and processed via extrusion.

The plastics used in the present method include polyethylene (PE) and Nylon resins. However, a similar approach can be extended to other thermoplastic and thermoset resins including but not limited to polyolefins, polyacrylates, polyfluoroolefins, polycarbonates, polyvinyl esters, acrolein/butadiene/styrene (ABS) resins, polyamides, polyesters, polyacrylonitriles, polysulfones, polysulfides, polybenzimidazoles, acetals, thermoplastic polyurethanes and polyureas, thermoplastic vulcanizate resins, thermoplastic elastomers, rubbers, and silicones.

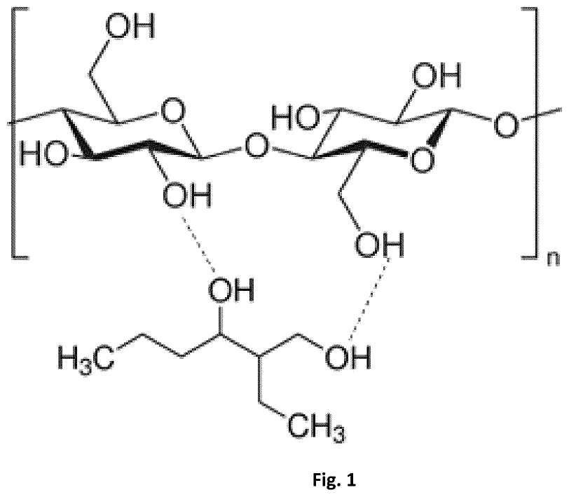

A specific plasticizer that can also act as a compatibilizer between dissimilar nylon/CNF interfaces is 2-ethyl-1,3-hexanediol (EHD). As shown in FIG. 1, EHD “modifies” the CNF for compatibilization with CNF through hydrogen bonding. While the polar —OH groups bind to cellulose surface, the hydrophobic aliphatic hydrocarbon moiety of EHD makes the CNF/EHD aggregate compatible in the plastic medium. The use of a compatibilizer/plasticizer compound coupled with CNF improves the tensile and flexural properties of the plastic material produced, both as made and after a variety of typical automotive use exposure conditions, such as humidity, fluid (hydrocarbon, oil, etc.), and thermal exposures. The high tensile and flexural strength coupled with the high fluid, moisture and heat resistance makes CNF-containing fiber reinforced polymers attractive for making polymer tubing products used in hydraulic brakes, transmission fluid and coolant lines in both gasoline powered and electrical vehicles.

To make composites using EHD as a compatibilizer/plasticizer, the water and/or organic solvent used for reactions and CNF dispersal is replaced by sequential dispersions of a slurry of CNF in EHD followed by filtration of the liquid phase. The EHD plasticizer acts as a cellulose surface compatibilizer with the nylon plastic matrix. Thus, the wet slurry of unmodified CNF in EHD can be directly blended with the plastics, thus avoiding very expensive and energy-consuming step of drying and pulverizing the CNF additive. The results presented herein show that unmodified CNF/EHD filler is a competitive alternative to the chemical treatment (covalent chemical modifications of cellulose). If warranted by mechanical performance of a CNF/plastic composite, the covalent chemical modification step can be added to the overall process.

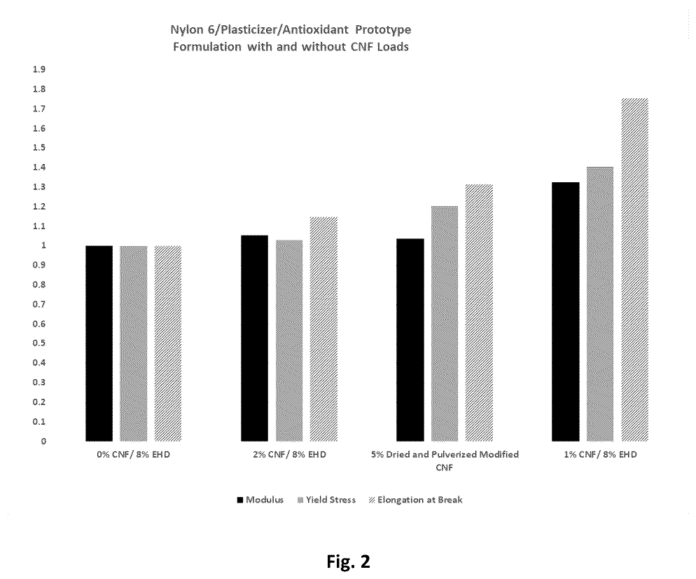

For Nylon 6/CNF composites, the unmodified CNF/EHD additive is the most effective at a load of 1%, showing a considerable decline of the tensile properties already at 2% concentration. The results of different loads and treatments of CNF in EHD suspension in CNF/Nylon 6 composites are shown in Table 1. FIG. 2 compares Nylon 6/Plasticizer/Antioxidant prototype formulation with and without CNF loads. The chart shows that at 5% concentration the dried and pulverized CNF is inferior to the performance of 1% unmodified CNF/EHD additive.

TABLE 1
Different loads and treatments of CNF in
EHD suspension in CNF/Nylon 6 composites.

| | | | Normalized |
|---|---|---|---|
| CNF Load/ | Modulus, | Strength, | Elongation |
| Modification | MPa | MPa | at Break |
| 0% CNF/8% EHD | 1412.13 | 29.93 | 1.00 |
| 2% CNF/8% EHD | 1489.66 | 30.81 | 1.15 |
| 1% CNF/8% EHD | 1551.74 | 40.30 | 1.76 |

The CNF combination used to blend with the plastic is not milled, pulverized, compounded, or dried prior to addition to thermoplastic or thermoset resins. The “wet” method disclosed herein uses unmodified CNF, which significantly reduces time and energy consumption while yielding comparable, or improved, modulus, yield stress, and elongation at break. The addition of 1% unmodified CNF yielded 33% improvements in modulus, 41% improvement in yield stress, and 76% improvement of elongation at break. Table 1 shows results from the addition of 1% unmodified CNF and the addition of 2% CNF compared to a baseline sample with no CNF.

The EHD solvent dispersion/filtration process described earlier commonly yields the EHD concentration around 75% wt., and approximately 10% wt. of CNF. When the mixture is blended into a plastic and the moisture evaporates during the extrusion process, the ratio of CNF/EHD in extruded plastic becomes approximately 1:8. Thus the 8% wt. concentration is identified as the preferred concentration for EHD; however, more dilute or more concentrated slurries can also be made and blended into nylons. The benefits of omitting any drying, pulverizing, milling, and waiting steps may still provide commercial advantage in cases with lesser or greater EHD concentration.

The “wet method” of blending modified or unmodified CNF as a paste with a plasticizer, such as EHD, which also acts as a surface compatibilizer by having both polar and nonpolar groups in the same molecule, provides a more economic and practical method of producing reinforced polymer composites. A series of CNF reinforced Nylon 6, Elvamide® 8601 and Zytel® 158 (Polyamide 6/12) plastics have also been made using a “wet-method”, where the CNF/EHD slurry was blended directly into a plastic without drying/pulverizing step. The results for the nonconditioned Zytel® 158 and Elvamide® samples are shown in Table 2 and Table 3, respectively. For both composites, the 1% CNF/8% EHD formulation shows superiority in yield stress, modulus, and elongation at break. The CNF/Elvamide® formulation also showed improvement in stress at break.

TABLE 2
Different loads and treatments of CNF in EHD suspension
in CNF/Zytel ® 158 composites.

| | Yield | | Normalized |
|---|---|---|---|
| | Stress, | Modulus, | Elongation |
| Formulation | MPa | MPa | at Break |
| 0% CNF/8% EHD | 33.61 | 672.29 | 1.00 |
| 1% CNF/8% EHD | 43.38 | 700.28 | 1.56 |

TABLE 3
Different loads and treatments of CNF in EHD suspension
in CNF/Elvamide ® composites.

| | Yield | | Stress at | Normalized |
|---|---|---|---|---|
| | Stress, | Modulus, | Break, | Elongation |
| Formulation | MPa | MPa | MPa | at Break |
| 0% CNF/8% EHD | 23.13 | 238.93 | 47.36 | 1.00 |
| 1% CNF/8% EHD | 26.23 | 307.50 | 57.25 | 1.14 |

To confirm longevity of the modified plastic composites, CNF-filled Nylon samples with unmodified CNF reinforcements were subjected to a variety of accelerated aging conditions relative to the automotive applications, such as humidity, oil aging, and thermal aging. These studies are important to assess the usability of the materials for a variety of commercial applications; for example, the automotive applications, where oil exposure, humidity and thermal aging are the common conditions.

Humidity Exposure: In the humidity conditioning study, all samples were conditioned at 50° C./98% RH for 3 days; all samples had 1% unmodified CNF with 8% of EDH. The results for Nylon 6, Elvamide®, and Zytel® 158 are shown Table 4, Table 5, and Table 6, respectively.

TABLE 4
CNF in EHD suspension in CNF/Nylon 6 composites
after exposure to 50° C./98% RH humidity.

| | | Yield | Normalized |
|---|---|---|---|
| | Modulus, | Stress, | Elongation |
| Formulation | MPa | MPa | at Break |
| 0% CNF/8% EHD | 1412.13 | 29.93 | 1 |
| 0% CNF/8% EHD | 642.51 | 15.58 | 2.39 |
| Conditioned | | | |
| 1% CNF/8% EHD | 1551.74 | 40.3 | 2.03 |

TABLE 5
CNF in EHD suspension in CNF/Elvamide ® composites
after exposure to 50° C./98% RH humidity.

| | Yield | | | Normalized |
|---|---|---|---|---|
| | Stress, | Modulus, | Stress at | Elongation |
| Formulation | MPa | MPa | Break, MPa | at Break |
| 0% CNF/8% EHD | 23.13 | 238.93 | 47.36 | 1.00 |
| 0% CNF/8% EHD | 9.60 | 96.11 | 29.77 | 1.63 |
| Conditioned | | | | |
| 1% CNF/8% EHD | 10.68 | 120.68 | 30.69 | 1.57 |
| Conditioned | | | | |

TABLE 6
CNF in EHD suspension in CNF/Zytel ® 158 composites
after exposure to 50° C./98% RH humidity.

| | | | Normalized |
|---|---|---|---|
| | Yield | Modulus, | Elongation |
| Formulation | Stress, MPa | MPa | at Break |
| 0% CNF/8% EHD | 33.61 | 672.28 | 1.00 |
| 0% CNF/8% EHD | 34.8 | 527.82 | 1.49 |
| Conditioned | | | |
| 1% CNF/8% EHD | 37.01 | 502.79 | 1.44 |
| Conditioned | | | |

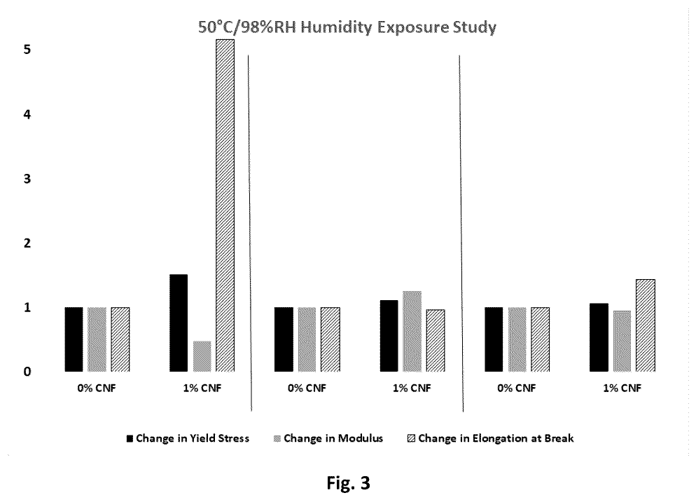

FIG. 3 shows humidity exposure properties comparison for CNF modified plastics versus plastics with no CNF (all materials contain 8% EHD). The Y-axis is normalized to the plastic with no CNF additive. The results show clear superiority of 1% wt. CNF/8% EHD blend in comparison to other compounding combinations including the dried and pulverized unmodified CNF dispersion in improvements of the yield stress, tensile modulus, and elongation at break. The humidity exposure data for Nylon 6, Elvamide®, and Zytel® 158 demonstrate the comparable resistance of CNF-containing composites to the baseline samples with no CNF. Zytel® 158 FRPs showed similar modulus compared to the unreinforced sample in the humidity exposure studies. The yield stress retention was greater for the unmodified CNF, whereas the elongation at break increase was greater for the treated samples.

Oil Aging: Due to its potential automotive application, tests were performed with aging of the RFPs in 80W-90 Castrol engine oil. The samples were soaked in the oil for 3 days at 125° C., which is the highest temperature for under-the-hood automotive applications. The results for Nylon 6, Elvamide®, and Zytel® 158 are shown Table 7, Table 8, and Table 9, respectively.

TABLE 7
CNF in EHD suspension in CNF/Nylon 6 composites
after soak in engine oil for 3 days at 125° C.

| | | Yield | Normalized |
|---|---|---|---|
| CNF Load/ | Modulus, | Stress, | Elongation |
| Modification | MPa | MPa | at Break |
| 0% CNF/8% EDH | 1412.13 | 29.93 | 1.00 |
| 0% CNF/8% EDH Oil Aged | 1874.77 | 41.59 | 1.25 |
| 1% CNF/8% EDH | 1551.74 | 40.3 | 2.03 |
| 1% CNF/8% EDH Oil Aged | 1721.08 | 42.08 | 1.99 |
| 2% CNF/8% EDH | 1489.66 | 30.81 | 1.15 |
| 2% CNF/8% EDH Oil Aged | 1806.95 | 40.90 | 1.31 |

TABLE 8
CNF in EHD suspension in CNF/Elvamide ® composites after
soak in engine oil for 3 days at 125° C.

| | Yield | | | Normalized |
|---|---|---|---|---|
| | Stress, | Modulus, | Stress at | Elongation |
| Formulation | MPa | MPa | Break, MPa | at Break |
| 0% CNF/8% EHD | 23.13 | 238.93 | 47.36 | 1.00 |
| 0% CNF/8% EHD | 38.89 | 399.76 | 41.23 | 0.21 |
| Conditioned | | | | |
| 1% CNF/8% EHD | 38.11 | 335.65 | 38.56 | 0.77 |
| Conditioned | | | | |

TABLE 9
CNF in EHD suspension in CNF/Zytel ® composites after
soak in engine oil for 3 days at 125° C.

| | Yield | | Normalized |
|---|---|---|---|
| | Stress, | Modulus, | Elongation |
| Formulation | MPa | MPa | at Break |
| 0% CNF/8% EHD | 33.61 | 672.29 | 1.00 |
| 0% CNF/8% EHD | 48.24 | 843.85 | 0.21 |
| Conditioned | | | |
| 1% CNF/8% EHD | 52.10 | 784.41 | 0.77 |
| Conditioned | | | |

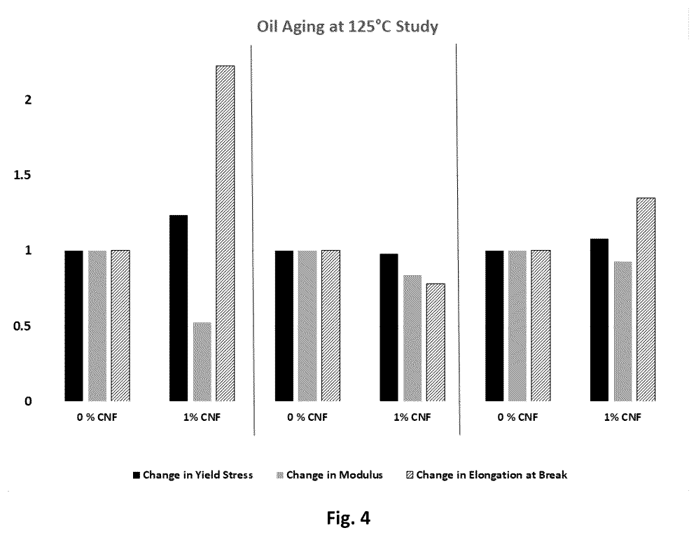

The oil aging results vary between the resins, loads of CNF, and CNF modifications. FIG. 4 shows oil aging properties comparison for CNF modified plastics versus plastics with no CNF (all materials contain 8% EHD). The y-axis is normalized to the plastic with no CNF additive. In case of Nylon 6, 1% unmodified CNF showed a modest decline in yield stress, while exhibiting increase in both modulus and elongation at break. At the same time, 2% Nylon 6/CNF sample remained essentially on par with the baseline control.

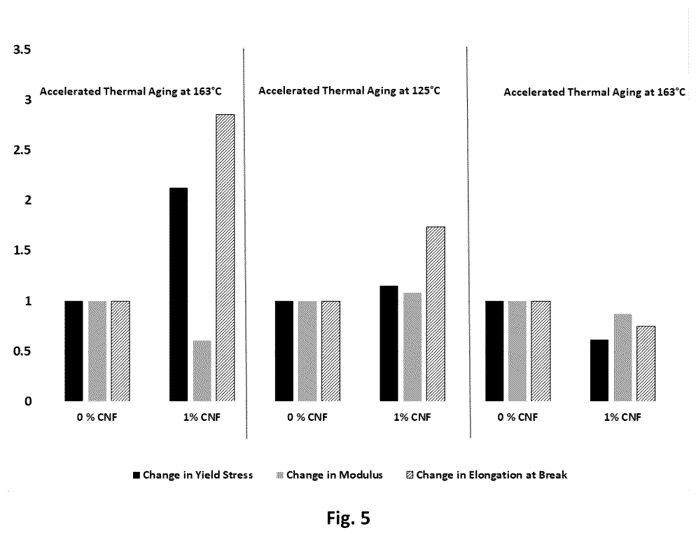

Thermal Aging: Thermal aging is also important aging mechanism for the materials that go into under-the-hood automotive applications. Thus, tests were performed with accelerated aging for Nylon 6 and Zytel® 158 materials, exposing them to 7 days of heat soak at 163° C., which is equivalent to 5,000 Continuous Use Temperature (CUT) at 125° C., which is the highest use temperature for under-the-hood automotive applications. In case of Elvamide®, that has the melting temperature at 159° C., the thermal aging was performed at 125° C. for the duration of 7 days. The results are presented in Table 10, Table 11, and FIG. 5.

TABLE 10
CNF in EHD suspension in CNF/Nylon 6 composites
after thermal aging for 7 days at 163° C.

| | Yield | | Normalized |
|---|---|---|---|
| | Stress, | Modulus, | Elongation |
| Formulation | MPa | MPa | at Break |
| 0% CNF/8% EHD | 29.93 | 1412.13 | 1.00 |
| 0% CNF/8% EHD | 20.06 | 1907.90 | 0.78 |
| Conditioned | | | |
| 1% CNF/8% EHD | 43.81 | 1197.42 | 2.24 |
| Conditioned | | | |

TABLE 11
CNF in EHD suspension in CNF/Elvamide ® composites
after thermal aging for 7 days at 125° C.

| | Yield | | | Normalized |
|---|---|---|---|---|
| | Stress, | Modulus, | Stress at | Elongation |
| Formulation | MPa | MPa | Break, MPa | at Break |
| 0% CNF/8% EHD | 23.13 | 238.93 | 47.36 | 1.00 |
| 0% CNF/8% EHD | 40.65 | 465.59 | 40.65 | 0.06 |
| Conditioned | | | | |
| 1% CNF/8% EHD | 46.87 | 504.63 | 46.89 | 0.10 |
| Conditioned | | | | |

The use of untreated CNF/EHD dispersion opens a great opportunity for the industry to offset the cost of otherwise expensive CNF using only a small amount of it (1%); and b) excluding expensive processing steps, such as chemical modification followed by the solvent removal, drying and pulverizing to a fine powder. The use of unmodified CNF/EHD blend is a cheaper, more environmentally friendly, and less cumbersome path for the scale-up production. In all cases, the use of CNF/EHD dispersion yielded superior mechanical performance than the baseline samples with no CNF.

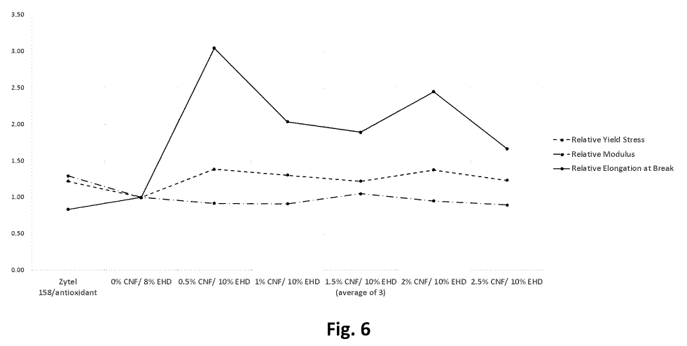

We have demonstrated the potential for one of the CNF/Zytel® formulations to be used in nylon automotive tubing. As a plastic matrix, Zytel® 158 plastic was selected for tests, which is already used for the manufacturing of automotive flexible tubing. For the filler, unmodified CNF/EHD dispersion is used. The criteria most important for such applications are the combination of acceptable tensile strength, high flexible strength, and the resistance to the oxidation and automotive fluids. The combination of the earlier tensile data and the technoeconomic analysis showed that the Zytel® 158 nylon 6/12 resin worked the best for the automotive applications. Thus, in the first optimization trial, the CNF loading was finalized at 1% wt. while varying the concentration of the EHD plasticizer between 5% to 15% wt. The results are shown in FIG. 6 and Table 12.

TABLE 12
Comparative tensile results for CNF/EHD/Zytel ® 158
blends with variable EHD load.

| | Yield | | Normalized |
|---|---|---|---|
| EHD variation | Stress, | Modulus, | Elongation |
| at 1% CNF | MPa | MPa | at Break |
| Zytel ® 158/antioxidant | 40.99 | 870.41 | 0.84 |
| 0% CNF/8% EHD | 33.61 | 672.29 | 1.00 |
| 1% CNF/5% EHD | 47.53 | 751.58 | 1.54 |
| 1% CNF/8% EHD | 43.38 | 700.28 | 1.56 |
| 1% CNF/10% EHD | 43.78 | 613.55 | 2.03 |
| 1% CNF/12% EHD | 43.04 | 598.1 | 2.15 |
| 1% CNF/15% EHD | 40.78 | 536.81 | 3.40 |

The EHD study showed that 10% is the optimal loading of the plasticizer. At this loading, the elongation at break is on the rise, indicative of increased flexibility, while both the yield stress and the tensile modulus are still high enough to sustain the burst pressure. At the higher EHD loadings both yield stress and modulus decline, while the elongation at break continues to rise. These properties are important flexible tubing.

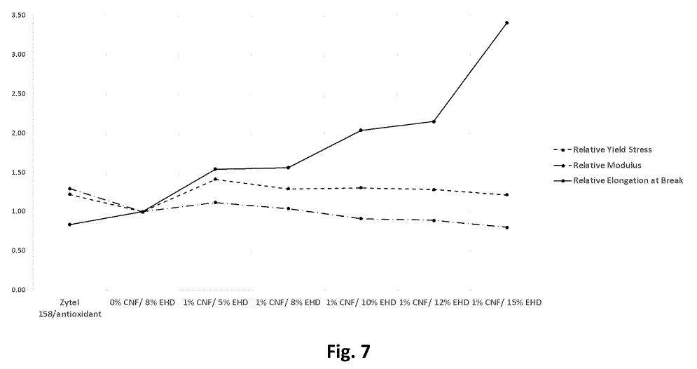

In the next step, using the 10% wt. load of the plasticizer, we varied the CNF content between 0.5-2.5% wt. The results are summarized in FIG. 7 and Table 13. The results indicate the combination of 0.5% CNF/10% EHD as the best for the elongation at break, yield stress, and modulus. The combination with 1.5% CNF/10% EHD came to be the second-best option with a similar (within the error margin) yield stress and tensile modulus, albeit at a somewhat lower elongation at break. The flexural strength/modulus estimates are based on the elongation at break values, which are the closest matched for the flexural strength/modulus estimates. The tensile test was repeated for the combination of 1.5% CNF/10% EHD three times to ensure reproducibility. All three runs were found to be within the error margin; thus, indicating the high reproducibility of the extrusion compounding method.

TABLE 13
Comparative tensile results for CNF/EHD/Zytel ® 158
resin blends with variable CNF load.

| | Yield | | Normalized |
|---|---|---|---|
| CNF variation | Stress, | Modulus, | Elongation |
| at 10% EHD | MPa | MPa | at Break |
| Zytel ® 158/antioxidant | 40.99 | 870.41 | 0.84 |
| 0% CNF/8% EHD | 33.61 | 672.29 | 1.00 |
| 0.5% CNF/10% EHD | 46.53 | 616.63 | 3.04 |
| 1% CNF/10% EHD | 43.78 | 613.55 | 2.03 |
| 1.5% CNF/10% EHD (average | 40.96 | 705.51 | 1.89 |
| of 3) | | | |
| 2% CNF/10% EHD | 46.2 | 639.51 | 2.45 |
| 2.5% CNF/10% EHD | 41.43 | 602.78 | 1.67 |

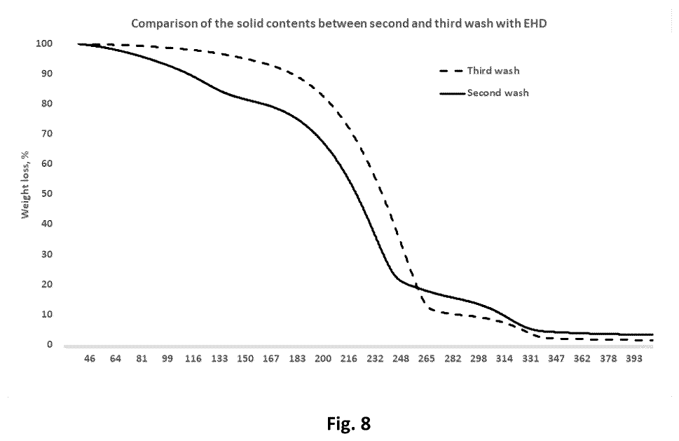

In the scale-up optimization, a process was designed where the 15% CNF slurry was shear mixed directly with EHD in 3 consecutive dispersion/filtration steps. According to TGA analysis, the blend had 12.4% of CNF content, 69.9% of EHD, and 17.7% of residual water. The content of the dispersion was found very similar to the previous large-scale and small-scale reactions. The TGA traces from the slurries after the second and third dispersion/filtration steps are shown in FIG. 8. The results show that after the second dispersion/filtration step there is still a significant amount (˜20% wt.) of the light volatiles, mostly water. Such moisture content was deemed too high for a successful extrusion. The moisture content after the 3rd step went down to the expected ˜10% range. Thus, all three of the EHD dispersion/filtrations steps are required to replace the water content in CNF slurry down to the level that was previously demonstrated to be acceptable for the plastic extrusion process with CNF fibers.

For exploring an EHD recovery step, we collected the cumulative filtrates that contained EHD, water, acetone, and purified by a fractional vacuum distillation. The overall recovery yield of EHD was measured at 74% wt. However, some of the EHD becomes a part of the final CNF/EHD suspension; hence, after recalculation for the amount of a plasticizer that went into the final slurry, the actual recovery yield was 82%. The purity of recycled EHD was confirmed by GC/MS and showed more than 99% pure product. Thus, the recycled EHD can be reused for the subsequent production batches with only 26% replenishment amount of fresh EHD for a new production batch. This quality in conjunction with the decreased energy use (due to omission of milling, pulverizing, complete drying of cellulose composite) provides a great environmental advantage of the present method over current methods of producing cellulose-reinforced polymer composites.

The disclosure provides a method for forming a nanocellulose or microcellulose reinforced polymer composite, comprising: providing an aqueous nanocellulose or microcellulose comprising a water content from 70 to 99.5 weight % water; adding an organic compatibilizer to the aqueous nanocellulose or microcellulose, forming a first combination; removing at least some water from the first combination, forming a second combination comprising more than 0 and less than 20 weight % water; adding the second combination to a thermoplastic resin, wherein the thermoplastic resin has a melting point above 200° C.; mixing the second combination and the thermoplastic resin while evaporating water from the second combination; and forming a nanocellulose or microcellulose-reinforced polymer composite.

In a preferred embodiment, the organic compatibilizer is a diol or polyol. More preferably, the organic compatibilizer is 2-ethyl-1,3-hexanediol (EHD). The organic compatibilizer is not covalently bonded to the aqueous nanocellulose or microcellulose. In an embodiment, the organic compatibilizer is a thermoset/thermoplastic polymer plasticizer additive. Preferably, the nanocellulose or microcellulose-reinforced polymer composite has improved mechanical and environmental properties, comprising improved tensile strength and modulus, flexural strength and modulus, short beam shear strength and modulus, flexural fatigue, compression strength and modulus, and abrasion before and after environmental exposure compared to a polymer composite without a nanocellulose or microcellulose additive.

In an embodiment, the second combination comprises 5-20 weight % water. Optionally, the second combination comprises 8-12 weight % water. Preferably, mixing the second combination and the thermoplastic resin while evaporating water from the second combination does not comprise complete drying or pulverizing of the second combination. Optionally, an antioxidant is added to the aqueous nanocellulose or microcellulose in addition to the organic compatibilizer, forming a first combination. Preferably, the first combination comprises 0.5 to 1 weight % antioxidant.

The thermoplastic resin may be selected from the group consisting: polyolefins, polyacrylates, polyfluoroolefins, polycarbonates, polyvinyl esters, polyvinylchlorides, acrolein/butadiene/styrene (ABS) resins, polyamides, polyesters, polyacrylonitriles, polysulfones, polysulfides, polyether ether ketone (PEEK) resins, polysulfones, polysulfides, polybenzimidazoles, acetals, thermoplastic polyurethanes and polyureas, thermoplastic vulcanizate resins, thermoplastic elastomers, rubbers, silicones, and nylons. Preferably, the thermoplastic resin is nylon.

In an embodiment, the aqueous nanocellulose or microcellulose comprises CNF, CNC, or CMP. Preferably, it is CNF. The first combination may comprise 5 to 15 weight % organic compatibilizers. The ratio of nanocellulose or microcellulose-reinforced polymer composite to organic compatibilizer (final product) may be 1:8, or accounting for error, 1±0.1 to 8±0.8. The nanocellulose or microcellulose-reinforced polymer composite may comprise 1-20 weight % of the nanocellulose or microcellulose and 99-80 weight % of the thermoplastic resin and other additives.

### Exemplary Embodiments

1. A process for replacing the water content in cellulosic products comprising of microsize cellulose particles, nanosized cellulose fibers, and nanosized cellulose crystals by blending thereof with an organic diol or polyol (EHD as an example) that acts as a compatibilizer allowing for homogeneous blending the cellulosic products into thermoplastic and thermoset resins, improves cellulose dispersion, and improves mechanical and environmental properties of the resulting cellulose/plastic composite materials.

In the first embodiment, the disclosure describes the way of blending of cellulose with diols or polyols that compatibilize the molecular surface with the thermoset or thermoplastic media yielding a homogeneous dispersion in a composite. The compatibilizer also replaces the majority of the moisture in a raw cellulose material. The moisture is known to be completely incompatible with the plastic media. Since the cellulose unit contains reactive hydroxyl (—OH) moieties on the surface, the cellulose molecule has strong intermolecular interactions (known as a non-covalent hydrogen bond) with other molecules that contain hydroxyl, amino, amido, imino, carboxyl, and fluorine groups. When compounded with a thermoset or thermoplastic, the compatibilizer becomes an integral part of the composite structure acting as a plasticizer. In the latter role, the polyol acts as a beneficial additive improving mechanical and environmental properties of a composite, such as mechanical strength, moisture, heat, and solvent resistance.

The types of the cellulosic products used in the invention include but not limited to Cellulose Nanofibers (CNF), Cellulose Nanocrystals (CNC), and Cellulose Microparticles (CMP). The cellulose products were used in an aqueous form to produce a comparable, or improved, reinforced polymer composite product by the disclosed “wet” method using less energy, time, and resources.
2. The method of Exemplary Embodiment 1, wherein the cellulosic product is blended with a thermoplastic resin including but not limited to polyolefins, polyacrylates, polyfluoroolefins, polycarbonates, polyvinyl esters, polyvinylchlorides, acrolein/butadiene/styrene (ABS) resins, polyamides, polyesters, polyacrylonitriles, polysulfones, polysulfides, polyether ether ketone (PEEK) resins, polysulfones, polysulfides, polybenzimidazoles, acetals, thermoplastic polyurethanes and polyureas, thermoplastic vulcanizate resins, thermoplastic elastomers: rubbers and silicones.
3. The method of Exemplary Embodiment 2, wherein the blended cellulosic product improves the mechanical and environmental properties including but not limited to tensile strength and modulus; flexural strength and modulus; short beam shear strength and modulus; flexural fatigue; compression strength and modulus, abrasion before and after environmental exposure.

### EXAMPLES

1. CNF/EHD Slurry: To prepare the CNF/EHD slurry, 100 g of 15% wt. slurry of CNF were dispersed in 100 mL of EHD with vigorous mixing. After 20 minutes, the mixture was filtered on a Buchner funnel to remove most of the free liquid phase, whereupon the suspension/filtration procedure was repeated one more time. The concentrated CNF/EHD slurry was analyzed by TGA analysis. According to TGA, after the second step the CNF content reaches approximately 9% wt., while the plasticizer content was approximately 74% The remaining content of the mixture belongs to the moisture. Thus obtained “wet” slurry of CNF in EHD could be blended with nylon plastic at extrusion temperatures over 220° C., at which temperature all of the light volatiles quickly evaporated in a hopper, thus not obstructing the extrusion process. This enables the use of the wet CNF slurry in composite extrusion process without adding the expensive and energy consuming step of drying and pulverizing the cellulosic material.
2. CNF/Nylon 6: After preparing the CNF/EHD slurry, perform extrusion of CNF/Nylon 6 material (CNF/EHD dispersion). The neat Nylon 6 (from Millipore-Sigma) was mixed with a wet unmodified CNF paste in 2-ethyl-1,3-hexandiol (˜9% CNF content; 74% plasticizer) and antioxidant [Pentaerythritol tetrakis(3,5-di-tert-butyl-4-hydroxyhydrocinnamate) further referred as antioxidant]. The ratios were calculated to have 1% of CNF, 8% of plasticizer, and 0.5% of antioxidant in the blend. Alternatively, the CNF/EHD dispersion was squeezed between the filter papers until the weight reaches 1/2 of original weight. In the latter case, the CNF/EHD dispersion was blended with Nylon 6 and antioxidant to yield 2% CNF and 8% EHD in the mixture. The components were mixed using a steel propeller blade until the components become homogeneously dispersed. The mixture was fed into a hopper in approximately 7 grams portions at ˜220° C. barrel temperature of a twin-screw microcompounder. The continuous extruded filament was cut into the smaller pieces, which were further chopped into pellets. The pellets were dried overnight under vacuum at 80° C./25″ Hg and injection molded into the test samples.

Injection molding of CNF/Nylon 6 samples. The compounded pellets were dried overnight under vacuum at 80° C./25″ Hg. Approximately 1.7 g sample was charged into the injection molding apparatus chamber and heated 5 minutes at ˜250° C., whereupon the molten plastic was injected into the mold kept at 85° C. at 55 psi injection pressure. The dog bone tensile sample was demolded after 40 seconds. The samples were kept in zip lock backs and tested as-prepared under the ambient conditions unless specified otherwise.
3. CNF/Evlamide®: After preparing the CNF/EHD slurry, perform extrusion of CNF/Elvamide® 8601 material (CNF/EHD dispersion). The neat Elvamide® 8601 was mixed with a wet unmodified CNF paste in 2-ethyl-1,3-hexandiol (˜9% CNF content; 74% plasticizer) and antioxidant. The ratios were calculated to have 1% of CNF, 8% of plasticizer, and 0.5% of antioxidant in the blend. The components were mixed using a steel propeller blade until the components become homogeneously dispersed. The mixture was fed into a hopper in approximately 7 grams portions at ˜225° C. barrel temperature of a twin-screw microcompounder. The continuous extruded filament was cut into the smaller pieces, which were further chopped into pellets. The pellets were dried overnight under vacuum at 80° C./25″ Hg and injection molded into the test samples.

Injection molding of CNF/Elvamide® 8601 tensile samples. The compounded pellets were dried overnight under vacuum at 80° C./25″ Hg. Approximately 1.9 g sample was charged into the injection molding apparatus. chamber and heated 7 minutes at ˜220° C., whereupon the molten plastic was injected into the mold kept at 70° C. at 55 psi injection pressure. The dog bone tensile sample was demolded after 40 seconds. The samples were kept in zip lock bags and tested as-prepared under the ambient conditions unless specified otherwise.
4. CNF/Zytel® 158: After preparing the CNF/EHD slurry, perform extrusion of CNF/Zytel® 158 material (CNF/EHD dispersion). The neat Zytel® 158 was mixed with a wet unmodified CNF paste in 2-ethyl-1,3-hexandiol (˜9% CNF content; 74% plasticizer) and antioxidant. The ratios were calculated to have 1% of CNF, 8% of plasticizer, and 0.5% of antioxidant in the blend. The components were mixed using a steel propeller blade until the components become homogeneously dispersed. The mixture was fed into a hopper in approximately 7 grams portions at ˜225° C. barrel temperature of a twin-screw microcompounder. The continuous extruded filament was cut into the smaller pieces, which were further chopped into pellets. The pellets were dried overnight under vacuum at 80° C./25″ Hg and injection molded into the test samples.

Injection molding of CNF/Zytel® 158 tensile samples. The compounded pellets were dried overnight under vacuum at 80° C./25″ Hg. Approximately 1.7 g sample was charged into the injection molding apparatus chamber and heated 5 minutes at ˜250° C., whereupon the molten plastic was injected into the mold kept at 85° C. at 55 psi injection pressure. The dog bone tensile sample was demolded after 40 seconds. The samples were kept in zip lock backs and tested as-prepared under the ambient conditions unless specified otherwise.
5. CNF/Zytel 158 optimized material: After preparing the CNF/EHD slurry, perform extrusion of CNF/Zytel® 158 optimized material (CNF/EHD dispersion). The neat Zytel® 158 was mixed with a wet unmodified CNF paste in 2-ethyl-1,3-hexandiol (˜9% CNF content; 74% plasticizer) and antioxidant. The ratios were calculated to have variable amounts of CNF and EHD plasticizer, and 0.5% of antioxidant in the blend. The components were mixed using a steel propeller blade until the components become homogeneously dispersed. The mixture was fed into a hopper in approximately 7 grams portions at ˜225° C. barrel temperature of a twin-screw microcompounder. The continuous extruded filament was cut into the smaller pieces, which were further chopped into pellets. The pellets were dried overnight under vacuum at 80° C./25″ Hg and injection molded into the test samples.

Injection molding of CNF/Zytel® 3060 tensile samples (optimized material). The compounded pellets were dried overnight under vacuum at 80° C./25″ Hg. Approximately 1.7 g sample was charged into the injection molding apparatus chamber and heated 7 minutes at ˜270° C., whereupon the molten plastic was injected into the mold kept at 70° C. at 55 psi injection pressure. The dog bone tensile sample was demolded after 40 seconds. The samples were kept in zip lock backs and tested as-prepared under the ambient conditions unless specified otherwise.

What is claimed is:

1. A method for forming a nanocellulose or microcellulose-reinforced polymer composite, comprising:
a) providing an aqueous nanocellulose or microcellulose comprising a water content from 70 to 99.5 weight % water;
b) adding a 2-ethyl-1,3-hexanediol to the aqueous nanocellulose or microcellulose, forming a first combination wherein the 2-ethyl-1,3-hexanediol is not covalently bonded to the aqueous nanocellulose or microcellulose;
c) removing at least some water from the first combination, forming a second combination comprising 5-20 weight % water;
d) adding the second combination to a nylon, wherein the nylon has a melting point above 200° C.;
e) mixing the second combination and the nylon while evaporating water from the second combination;
f) forming a nanocellulose or microcellulose-reinforced polymer composite; and,
wherein, the method does not comprise a step of pulverizing or milling the nanocellulose or microcellulose.

2. The method of claim 1, wherein step b) further comprises adding an antioxidant to the aqueous nanocellulose or microcellulose.

3. The method of claim 2, wherein the first combination comprises 0.5 to 1 weight % antioxidant.

4. The method of claim 1, wherein the nanocellulose or microcellulose-reinforced polymer composite has improved mechanical and environmental properties, comprising improved tensile strength and modulus, flexural strength and modulus, short beam shear strength and modulus, flexural fatigue, compression strength and modulus, and abrasion before and after environmental exposure compared to a polymer composite without a nanocellulose or microcellulose additive.

5. The method of claim 1, wherein the aqueous nanocellulose or microcellulose comprises CNF, CNC, or CMP.

6. The method of claim 5, wherein the aqueous nanocellulose or microcellulose comprises CNF.

7. The method of claim 1, wherein the first combination comprises 5 to 15 weight % 2-ethyl-1,3-hexanediol.

8. The method of claim 1, wherein the nanocellulose or microcellulose-reinforced polymer composite comprises a ratio of the nanocellulose or microcellulose to the 2-ethyl-1,3-hexanediol of 1±0.1 to 8±0.8.

9. The method of claim 1, wherein the nanocellulose or microcellulose-reinforced polymer composite comprises 1-20 weight % of the nanocellulose or microcellulose and 99-80 weight % of the nylon and other additives.

10. The method of claim 1, wherein the nylon is Nylon 6.

11. A method for forming a nanocellulose or microcellulose-reinforced polymer composite, comprising:
a) providing an aqueous nanocellulose or microcellulose comprising a water content from 70 to 99.5 weight % water;
b) adding a 2-ethyl-1,3-hexanediol to the aqueous nanocellulose or microcellulose, forming a first combination wherein the 2-ethyl-1,3-hexanediol is not covalently bonded to the aqueous nanocellulose or microcellulose;
c) removing at least some water from the first combination, forming a second combination comprising 8-12 weight % water;
d) adding the second combination to a nylon, wherein the nylon has a melting point above 200° C.;
e) mixing the second combination and the nylon while evaporating water from the second combination;
f) forming a nanocellulose or microcellulose-reinforced polymer composite; and,
wherein, the method does not comprise a step of pulverizing or milling the nanocellulose or microcellulose.

12. The method of claim 11, wherein step b) further comprises adding an antioxidant to the aqueous nanocellulose or microcellulose.

13. The method of claim 12, wherein the first combination comprises 0.5 to 1 weight % antioxidant.

14. The method of claim 11, wherein the nanocellulose or microcellulose-reinforced polymer composite has improved mechanical and environmental properties, comprising improved tensile strength and modulus, flexural strength and modulus, short beam shear strength and modulus, flexural fatigue, compression strength and modulus, and abrasion before and after environmental exposure compared to a polymer composite without a nanocellulose or microcellulose additive.

15. The method of claim 11, wherein the aqueous nanocellulose or microcellulose comprises CNF, CNC, or CMP.

16. The method of claim 15, wherein the aqueous nanocellulose or microcellulose comprises CNF.

17. The method of claim 11, wherein the first combination comprises 5 to 15 weight % 2-ethyl-1,3-hexanediol.

18. The method of claim 11, wherein the nanocellulose or microcellulose-reinforced polymer composite comprises a ratio of the nanocellulose or microcellulose to the 2-ethyl-1,3-hexanediol of 1±0.1 to 8±0.8.

19. The method of claim 11, wherein the nanocellulose or microcellulose-reinforced polymer composite comprises 1-20 weight % of the nanocellulose or microcellulose and 99-80 weight % of the nylon and other additives.

20. The method of claim 11, wherein the nylon is Nylon 6.
